(19) United States
(12) Patent Application Publication
(10) Pub. No.: US 2024/0226615 A9
(43) Pub. Date: Jul. 11, 2024

(54) MASK DEVICE

(71) Applicant: LG ELECTONICS INC., Seoul (KR)

(72) Inventors: Chiyoung CHOI, Seoul (KR); Hojung KIM, Seoul (KR); Hyungho PARK, Seoul (KR); Sangkyun BAEK, Seoul (KR); Yeongcheol MUN, Seoul (KR); Keonwang LEE, Seoul (KR)

(21) Appl. No.: 18/278,258

(22) PCT Filed: Aug. 17, 2022
(86) PCT No.: PCT/KR2022/012236

§ 371 Date: Aug. 22, 2023

(30) Foreign Application Priority Data
Aug. 23, 2021 (KR) 10-2021-0110992

(51) Int. Cl. A62B 18/00; A62B 23/02

(52) U.S. Cl. CPC A62B 18/006; A62B 23/025

(57) ABSTRACT

A mask device according to an embodiment of the present invention comprises: a mask cover having air suction openings for suctioning air; a mask body, which is coupled to the mask cover, has fan modules, fixed thereto, for causing air having flowed in through the air suction openings to flow, and has an air discharge opening for ejecting the air flowing by means of the fan modules and an air outlet for discharging the air to the outside; and a sealing part, which is separably coupled to the rear surface of the mask body, and has a first body coupling part supported by means of the upper part of the mask body and a second body coupling part supported by means of the lower part of the mask body.

### CROSS-REFERENCE TO RELATED PATENT APPLICATIONS

This application is a U.S. National Stage Application under 35 U.S.C. § 371 of PCT Application No. PCT/KR2022/012236, filed Aug. 17, 2022, which claims priority to Korean Patent Application No. 10-2021-0110992, filed Aug. 23, 2021, whose entire disclosures are hereby incorporated by reference.

### TECHNICAL FIELD

The present disclosure relates to a mask device.

### BACKGROUND ART

In general, a mask is a device that covers the nose and mouth of a user to prevent inhalation of germs, dust, or the like, and droplet transmission by viruses or bacteria.

The mask is in close contact with the user's face to cover the user's nose and mouth. The mask filters germs, dust, or the like included in the air introduced into the user's nose and mouth, and allows the filtered air to be introduced into the user's mouth and nose. Air and germs, dust, or the like included in the air pass through the body of the mask including the filter, and germs, dust, or the like is filtered by the body of the mask.

However, since external air is introduced into the nose and mouth of the user after passing through the body of the mask, and the air exhaled by the user also flows out to the outside after passing through the body of the mask, the user's breathing does not occur smoothly. Recently, a mask equipped with a motor, a fan, and a filter has been developed in order to solve the above-mentioned inconvenience of breathing.

For example, in Korean Patent Publication No. 10-2016-0129562, an “air suction type mask” is disclosed. the air suction type mask according to the prior art includes a face cover, a wearing portion coupled to the face cover, a filter disposed between the face cover and the wearing portion, an air passage portion, and a suction fan.

However, according to the prior art, the outer rim of the wearing portion made of silicone is fitted along the outer rims of the face cover and the air passage portion, but in the process of fitting the outer rim, there is an inconvenience in coupling due to interference between the two outer rims.

In addition, when the wearing portion forming the rear surface of the mask is separated from the face cover and the air passage portion, the mask is disassembled, so that internal components of the mask are unnecessarily exposed to the outside.

In addition, when the wearing portion made of silicon is in close contact with the user's face for a long time, there is a problem in that sweat is generated between the user's face and the wearing portion.

### DISCLOSURE

### Technical Problem

An object of the present disclosure is to provide a mask device for improving the above problems.

Specifically, an object of the present disclosure is to provide a mask device capable of enhancing use convenience.

In addition, an object of the present disclosure is to provide a mask device in which fastening and coupling can be easily performed and coupling force can be improved.

In addition, an object of the present disclosure is to provide a mask device capable of removing sweat generated on the face.

Further, an object of the present disclosure is to provide a compact mask device as well as reducing manufacturing cost.

### Technical Solution

A mask device according to an embodiment of the present disclosure for achieving the above object may include a mask cover, a mask body coupled to the mask cover, and a sealing portion separably coupled to a rear surface of the mask body, and having a first body coupling portion supported on an upper portion of the mask body and a second body coupling portion supported on a lower portion of the mask body, so that the sealing portion in close contact with the user's face is stably supported on the rear surface of the mask body.

In addition, in the mask device, the first body coupling portion and the second body coupling portion may be formed on a sealing front portion contacting the rear surface of the mask body to facilitate coupling between the mask rear surface and the sealing portion.

In addition, in the mask device, the first body coupling portion is supported on the upper portion of the mask body by magnetic force, and the second body coupling portion is supported on the lower portion of the mask body by engaging and fixing to improve the ease of coupling while making it easy to separate.

In addition, the mask device may include a plurality of ventilation holes through which air is ejected to the user's face, thereby preventing sweat from being generated on the user's face by the sealing portion.

In addition, since the mask device couples the sealing portion to the rear surface of the mask body, maintenance is easy by attaching and detaching only the sealing portion from the body of the mask formed by coupling the mask body and the mask cover, and since only the sealing portion is attached and detached, the maintenance of the mask body may also be easy.

### Advantageous Effect

According to the mask device according to the embodiment of the present disclosure having the above configuration, the following effects are obtained.

First, according to the present disclosure, the maintenance work of the mask device has the advantage of being easy.

Second, there is an advantage of easy washing of the sealing portion and the rear surface of the mask that are in close contact with the user's face.

Third, since the upper and lower portions of the sealing portion are supported by the upper and lower portions of the mask, respectively, the coupling force between the sealing portion and the mask is improved.

Fourth, by wearing a mask, sweat generated on the user's face can be removed to provide a comfortable fit.

Fifth, the manufacturing cost can be reduced by integrally forming the sealing portion having the coupling structure.

Sixth, since it has a simple coupling structure, it is possible to provide a mask device that users of various ages can easily use.

### DESCRIPTION OF DRAWINGS

FIG. 1 is a left perspective view illustrating a mask device according to an embodiment of the present disclosure.

FIG. 2 is a right perspective view illustrating a mask device according to an embodiment of the present disclosure.

FIG. 3 is a rear view illustrating a mask device according to an embodiment of the present disclosure.

FIG. 4 is a bottom view illustrating a mask device according to an embodiment of the present disclosure.

FIG. 5 is an exploded perspective view illustrating a mask device according to an embodiment of the present disclosure.

FIGS. 6 and 7 are views illustrating the flow of air when operating the mask device according to an embodiment of the present disclosure.

FIG. 8 is a view illustrating a sealing assembly mounted on a mask device according to an embodiment of the present disclosure.

FIG. 9 is a view illustrating a sealing assembly separated from a mask device according to an embodiment of the present disclosure.

FIG. 10 is a perspective view illustrating a sealing assembly according to an embodiment of the present disclosure.

FIG. 11 is an exploded perspective view illustrating a sealing assembly according to an embodiment of the present disclosure.

FIG. 12 is a cross-sectional view taken along line 12″-12″ of FIG. 10.

### BEST MODE

Hereinafter, a mask device according to an embodiment of the present disclosure will be described in detail with reference to the drawings.

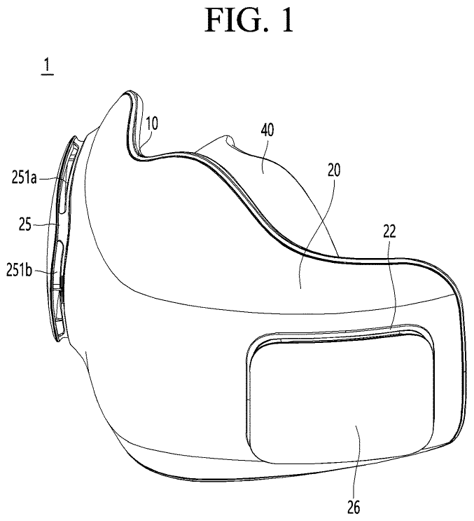

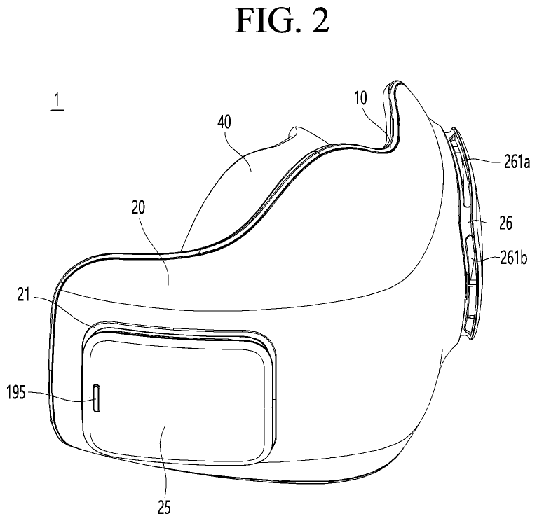

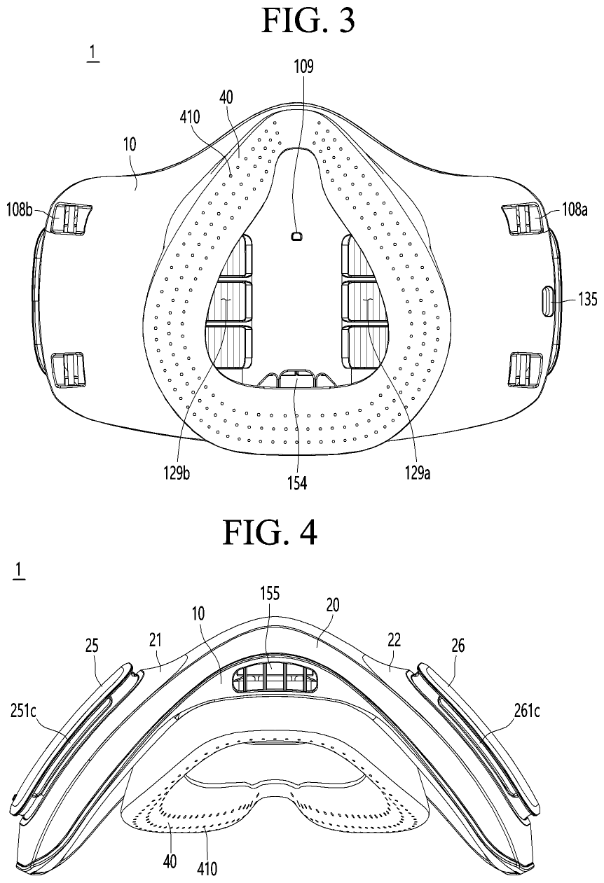

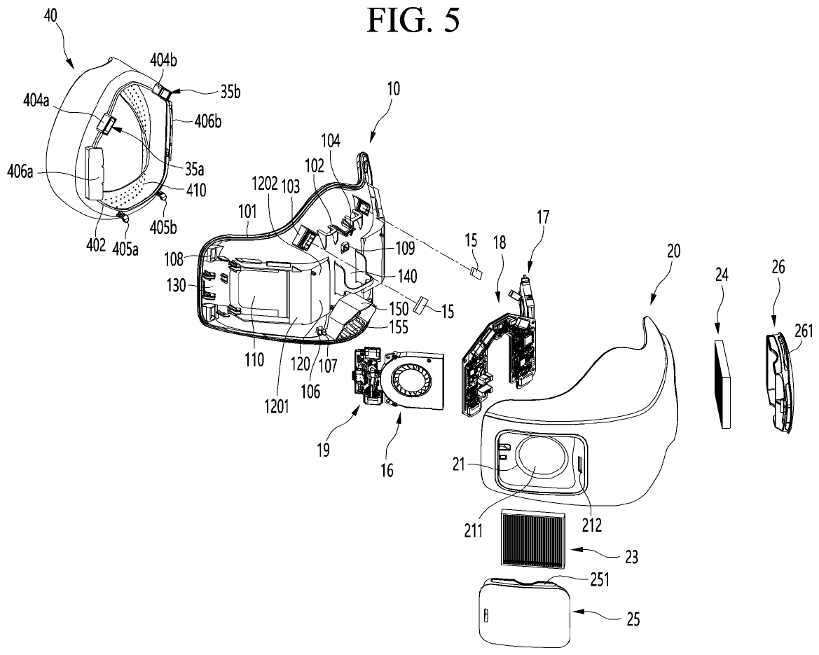

FIG. 1 is a left perspective view illustrating a mask device according to an embodiment of the present disclosure, FIG. 2 is a right perspective view illustrating a mask device according to an embodiment of the present disclosure, FIG. 3 is a rear view illustrating a mask device according to an embodiment of the present disclosure, and FIG. 4 is a bottom view illustrating a mask device according to an embodiment of the present disclosure.

Referring to FIGS. 1 to 4, a mask device 1 according to an embodiment of the present disclosure may include a mask body 10 and a mask body cover 20 coupled to the mask body 10.

The mask body 10 and the mask body cover 20 may be separably coupled. When the mask body 10 and the mask body cover 20 are coupled, an inner space may be formed between the mask body 10 and the mask body cover 20. Components for driving the mask device 1 may be disposed in the inner space. The inner space may be formed between the front surface of the mask body 10 and the rear surface of the mask body cover 20. The mask body 10 may define the rear surface of the mask device 1, and the mask body cover 20 may define the front surface of the mask device 1.

The rear of the mask device 1 defines the direction in which the rear surface of the mask device 1 facing the user's face is located, and the front of the mask device 1 is the opposite direction of the rear and is defined as the direction in which the front of the mask device exposed to the outside is located.

The mask device 1 may further include a sealing portion 40 separably coupled to the mask body 10.

When the sealing portion 40 is coupled to the rear surface of the mask body 10, the sealing portion 40 may be supported by the mask body 10. When the sealing portion 40 is separated from the rear surface of the mask body 10, the rear surface of the mask body 10 is exposed to the outside, and the user can clean easily the rear surface of the mask body 10 and the sealing portion 40.

When the sealing portion 40 is supported on the rear surface of the mask body 10, a breathing space for breathing may be defined between the sealing portion 40 and the rear surface of the mask body 10. The sealing portion 40 may be in close contact with the user's face and surround the user's nose and mouth to restrict external air from entering the breathing space.

The mask body cover 20 may include a first filter mounting portion 21 and a second filter mounting portion 22. The first filter mounting portion 21 may be located on the right side of the mask body cover 20, and the second filter mounting portion 22 may be located on the left side of the mask body cover 20.

Based on the mask device 1 worn on the user's face, a left direction (left) and a right direction (right) are defined. In other words, while the user is wearing the mask device 1, the right side of the user is defined as the right side of the mask device 1, and the left side of the user is defined as the left side of the mask device 1.

In addition, based on the mask device 1 mounted on the user's face, an upward direction (upward) and a downward direction (downward) are defined.

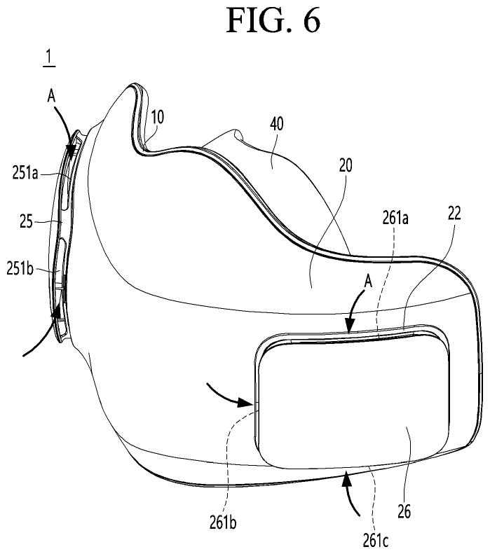

A first filter cover 25 may be mounted on the first filter mounting portion 21, and a second filter cover 26 may be mounted on the second filter mounting portion 22. Filters 23 and 24 (see FIG. 5) are disposed inside the first filter mounting portion 21 and the second filter mounting portion 22, and the first filter cover 25 and the second filter cover 26 may cover the filter.

The first filter cover 25 and the second filter cover 26 may be separably coupled to the first filter mounting portion 21 and the second filter mounting portion 22. For example, the first filter cover 25 and the second filter cover 26 may be fitted and coupled to the first filter mounting portion 21 and the second filter mounting portion 22, respectively.

Each of the first filter cover 25 and the second filter cover 26 may include a front portion and a side portion extending rearward along an edge or a rear edge of the front portion.

Each of the side portions of the first filter cover 25 and the second filter cover 26 may include four side surfaces, and the four side surfaces may include an upper side surface, a lower side surface, a left side surface, and a right side surface.

One or a plurality of first air inlets 251 may be formed on a side surface of the first filter cover 25. One or a plurality of second air inlets 261 may also be formed on the side surface of the second filter cover 26.

When the first filter cover 25 is mounted on the first filter mounting portion 21, the first air inlet 251 may be exposed to the outside. When the second filter cover 26 is mounted on the second filter mounting portion 22, the second air inlet 261 may be exposed to the outside.

The first air inlet 251 and the second air inlet 261 may be formed on side surfaces of the first filter cover 25 and the second filter cover 26. Although not illustrated, it should be noted that each of the first and second air inlets 251 and 261 may be formed on the front surface of each of the first and second filter covers 25 and 26.

The first air inlet 251 and the second air inlet 261 may be formed at points closer to the front portion from a line bisecting the side portion.

When a plurality of first air inlets 251 are provided on the side portion of the first filter cover 25, the first air inlets 251 may include first air suction holes 251a formed on the upper surface, a second air suction hole 251b formed on the left surface, and a third air suction hole 251c formed on the lower surface.

Similarly, when a plurality of second air inlets 261 are provided on the side surface of the second filter cover 26, the second air inlets 261 may include first air suction hole 261a formed on the upper surface, a second air suction hole 261b formed on the right surface, and a third air suction hole 261c formed on the lower surface.

Meanwhile, an opening may be formed in any one of the first filter cover 25 and the second filter cover 26, and the opening may be formed on either edge of the first filter cover 25 and the second filter cover 26. In addition, a manipulation portion 195 for controlling the operation of the mask device 1 may be mounted in the opening. In this embodiment, an example in which the manipulation portion 195 is mounted on the first filter cover 25 will be described.

The manipulation portion 195 may function as an operation switch for turning on/off the power of the mask device 1. The manipulation portion 195 may be exposed toward the front of the mask device 1 in a state of being mounted in the opening.

The mask body 10 may include a hook mounting portion 108. The hook mounting portion 108 may be provided on the left and right sides of the mask body 10.

In other words, the hook mounting portion 108 may include a first hook mounting portion 108a provided on the right side of the mask body 10 and a second hook mounting portion 108b provided on the left side of the mask body 10.

Each of the first hook mounting portion 108a and the second hook mounting portion 108b may be provided in plural to be spaced apart from each other in the vertical direction of the mask body 10. In detail, the first hook mounting portion 108a may be provided on the upper right and lower right sides of the mask body 10, and the second hook mounting portion 108b may be provided on the upper left and lower left sides of the mask body 10.

A band for keeping the mask device 1 in close contact with the user's face may be mounted on the hook mounting portion 108.

For example, both end portions of the band may connect the first hook mounting portion 108a and the second hook mounting portion 108b, or may connect two first hook mounting portions 108a spaced apart in the vertical direction and two second hook mounting portions 108ba spaced apart in the vertical direction, respectively.

In the former case, the band will be wrapped around the back of the user's head, and in the latter case, the band will be engaged to both ears of the user.

The hook mounting portion 108 may be formed by cutting a portion of the mask body 10. Therefore, air may be introduced into the inner space between the mask body 10 and the mask body cover 20 through the gap formed in the hook mounting portion 108.

In detail, external air introduced into the inner space through the hook mounting portion 108 may cool the electronic components disposed in the inner space. In addition, the air whose temperature rises while cooling the electronic components may be discharged to the outside of the mask body 10 through the hook mounting portion 108 again. In addition, in order to limit the air introduced into the inner space through the hook mounting portion 108 from being introduced into the breathing space, the inside of the mask device 1 may have a sealing structure.

The mask body 10 may include an air discharge opening 129 for supplying filtered air to the breathing space. The user may inhale and breathe the filtered air supplied to the breathing space through the air discharge opening 129.

The air discharge opening 129 may include a first air discharge opening 129a for ejecting filtered air introduced into the first air inlet 251 into the breathing space, and a second air discharge opening 129b for ejecting filtered air introduced into the second air inlet 261 into the breathing space.

The first air discharge opening 129a may be disposed on the right side with respect to the center of the mask body 10, and the second air discharge opening 129b may be disposed on the left side. The air introduced into the first air inlet 251 may flow to the first air discharge opening 129a after passing through the filter 23. Air introduced into the second air inlet 261 may flow to the second air discharge opening 129b after passing through the filter 24.

The mask body 10 may include air outlets 154 and 155 for discharging air exhaled by the user to an external space. The air outlets 154 and 155 may be located below the mask body 10.

The air outlets 154 and 155 may include a first outlet 154 formed on the lower end of the front surface of the mask body 10 and a second air outlet 155 formed on the lower surface of the mask body 10.

In detail, a rib extending forward may be formed at the lower end of the front surface of the mask body 10, and a surface defined by the rib may be defined as a bottom surface of the mask body 10.

A flow space passing through the first air outlet 154 and flowing downward toward the second air outlet 155 may be formed between the mask body 10 and the mask body cover 20.

A check valve may be formed at one or more of the first air outlet 154 and the second air outlet 155. A phenomenon in which external air is introduced into the breathing space or air discharged through the second air outlet 155 flows backward may be prevented by the check valve.

The check valve may be located in a flow space between the first air outlet 154 and the second air outlet 155.

For example, a check valve in the form of a flat flap having a size and shape corresponding to the size and shape of the first air outlet 154 may be provided.

In detail, the upper end of the flap is connected to the upper edge of the first air outlet 154, so that when the user exhales, the flap bends or rotates to open the first air outlet 154, and when the user inhales, the flap comes into close contact with the first air outlet 154 to prevent external air or discharged air from re-introducing into the breathing space.

The mask body 10 may include a sensor mounting portion 109. A sensor for obtaining various types of information from the breathing space may be mounted on the sensor mounting portion 109. The sensor mounting portion 109 may be located above the mask body 10. The sensor mounting portion 109 may be positioned above the mask body 10 in consideration of a position where a pressure change in the breathing space can be constantly detected when a user breathes.

The mask body 10 may include a connector hole 135. The connector hole 135 may be understood as an opening in which a connector 192 for supplying power to the mask device 1 is installed. The connector hole 135 may be formed on any one side of the left edge and the right edge of the mask body 10.

In this embodiment, since the manipulation portion 195 and the connector 192 are connected to a power module 19 (see FIG. 5) to be described later, the connector hole 135 may be provided on any one side of the left and right sides of the mask body 10 corresponding to a position where the power module 19 is installed.

Hereinafter, components of the mask device 1 will be described in detail based on an exploded perspective view.

FIG. 5 is an exploded perspective view illustrating a mask device according to an embodiment of the present disclosure.

Referring to FIG. 5, the mask device 1 according to the present disclosure may include a mask body 10, a mask body cover 20, and a sealing portion 40.

In detail, the mask body 10 and the mask body cover 20 may be coupled to each other to form the outer shape of the mask device 1.

An internal space for accommodating components for operating the mask device 1 may be formed between the mask body 10 and the mask body cover 20. The sealing portion 40 is coupled to the rear surface of the mask body 10 to form a breathing space between the user's face and the mask body 10 and can prevent external air from introducing the breathing space.

The mask body 10 may include a cover coupling groove 101. The cover coupling groove 101 may be formed along the front edge of the mask body 10. The cover coupling groove 101 may be formed by a step. The cover coupling groove 101 may be formed to correspond to the edge of the mask body cover 20. The cover coupling groove 101 may be formed by recessing a portion of the front surface of the mask body 10 backward. The mask body cover 20 may be inserted into the cover coupling groove 101 by moving the mask body cover 20 toward the cover coupling groove 101 of the mask body 10.

The mask body 10 may include a first cover coupling portion 102. An upper portion of the mask body cover 20 may be supported by the first cover coupling portion 102. The first cover coupling portion 102 may be formed on the upper portion of the front surface of the mask body 10.

For example, the first cover coupling portion 102 may have a structure to which a hook can be coupled. A hook coupled to the first cover coupling portion 102 may be formed on the rear surface of the mask body cover 20.

A plurality of first cover coupling portions 102 may be provided, and a plurality of hooks corresponding to the first cover coupling portions 102 also may be provided. In this embodiment, the first cover coupling portion 102 may be provided on the left and right sides with respect to the center of the mask body 10. The first cover coupling portion 102 may be referred to as an upper cover coupling portion.

The mask body 10 may include a first sealing coupling portion 103. The first sealing coupling portion 103 may be located above the mask body 10. The first sealing coupling portion 103 may support an upper portion of the sealing portion 40.

For example, the first sealing coupling portion 103 is configured to couple the sealing portion 40 to the mask body 10 by magnetic force. To this end, a first magnetic member 15 may be provided in the first sealing coupling portion 103. The first magnetic member 15 may include either a magnet or a metal attached to a magnet.

The first magnetic member 15 may be fixed to the front surface of the mask body 10, and the sealing portion 40 may contact the rear surface of the mask body 10. In this embodiment, the first sealing coupling portion 103 may be formed in a rib shape where the front surface of the mask body 10 protrudes forward and surrounds the first magnetic member 15. The first magnetic member 15 may be inserted into and fixed to the first sealing coupling portion 103 formed in the rib shape. In this embodiment, it will be described that the first magnetic member 15 is provided as a magnet.

The first sealing coupling portion 103 may be provided on the left side and the right side, respectively, based on the center of the mask body 10. The first sealing coupling portion 103 may be defined as an upper sealing coupling portion.

The first magnetic member 15 may include a right first magnetic member mounted on the right first sealing coupling portion 103 and a left first magnetic member mounted on the left first sealing coupling portion 103.

A first body coupling portion 404 is formed in the sealing portion 40 so that the sealing portion 40 can be coupled to the mask body 10 by the magnetic force of the first magnetic member 15, and a second magnetic member 35 may be mounted on the first body coupling portion 404.

The first body coupling portion 404 is formed to firmly fix the second magnetic member 35. The second magnetic member 35 may include either a magnet or a metal attached to a magnet. In this embodiment, the second magnetic member 35 is described as being made of metal, but the first magnetic member 15 and the second magnetic member 35 may be made of opposite materials. In other words, one of the first magnetic member 15 and the second magnetic member 35 may be a magnet and the other may be a metal attached to the magnet.

The first body coupling portion 404 may be provided in plural to correspond to the plurality of first sealing coupling portions 103. The mask body 10 may include a support rib 104.

The support rib 104 may protrude forward from the front surface of the mask body 10. The support rib 104 may come into contact with the rear surface of the mask body cover 20 when the mask body cover 20 is coupled to the mask body 10.

The mask body 10 and the mask body cover 20 can resist external forces acting in the front and rear direction by the support ribs 104. A plurality of support ribs 104 may be provided on the front surface of the mask body 10.

Meanwhile, the support rib 104 may perform a function of fixing a portion of the control module 18 mounted on the mask body 10. To this end, the support rib 104 may be formed in a hook shape. In other words, an engagement protrusion protrudes from the end portion of the support rib 104 to fix the end portion of the control module 18.

The mask body 10 may include a second cover coupling portion 106.

The lower portion of the mask body cover 20 may be supported by the second cover coupling portion 106. The second cover coupling portion 106 may protrude from the lower portion of the front surface of the mask body 10 in the shape of a hook. The first cover coupling portion 102 may be provided on the left side and the right side, respectively, based on the center of the mask body 10. The second cover coupling portion 106 may be defined as a lower cover coupling portion.

On the rear surface of the mask body cover 20, hook engagement portions to which the second cover coupling portions 106 are coupled may be formed on left and right sides of the mask body cover 20, respectively.

The mask body 10 may include a second sealing coupling portion 107.

A lower portion of the sealing portion 40 may be supported by the second sealing coupling portion 107. The second sealing coupling portion 107 may be formed by opening the mask body 10. The second sealing coupling portion 107 may be located under the mask body 10. For example, the second sealing coupling portion 107 may be defined as a through-hole formed in the mask body 10.

A second body coupling portion 405 inserted into the second sealing coupling portion 107 may be formed in the sealing portion 40. A plurality of second sealing coupling portions 107 are provided, and A plurality of second body coupling portions 405 may also be provided to correspond to the second sealing coupling portion 107. In this embodiment, the second sealing coupling portion 107 may be provided on the left side and the right side based on the center of the mask body 10, respectively. The second sealing coupling portion 107 may be defined as a lower sealing coupling portion.

The mask body 10 may include the sensor mounting portion 109 mentioned above.

The sensor mounting portion 109 may be formed in a rib shape in which a portion of the front surface of the mask body 10 protrudes forward. In detail, the sensor mounting portion 109 is formed in the form of a rib around the edge of the sensor, and an installation space in which the sensor is installed is formed inside the sensor mounting portion 109.

A hole through which the installation space communicates with the breathing space is formed in the mask body 10 corresponding to the inside of the sensor mounting portion 109. The sensor disposed in the installation space includes a pressure sensor, and the pressure sensor may sense pressure information of the breathing space through the hole.

The mask body 10 may include a fan module mounting portion 110.

The fan module mounting portion 110 may include a first fan module mounting portion to which the first fan module 16 is mounted and a second fan module mounting portion to which the second fan module 17 is mounted.

The first fan module mounting portion and the second fan module mounting portion may be formed on the front surface of the mask body 10. In detail, the first fan module mounting portion may be disposed on the right side of the mask body 10, and the second fan module mounting portion may be disposed on the left side of the mask body 10.

Each of the first fan module 16 and the second fan module 17 may be separably coupled to the first fan module mounting portion and the second fan module mounting portion.

The mask body 10 may include an air duct portion 120.

The air duct portion 120 may be formed on the front surface of the mask body 10.

A flow path through which air may pass may be formed inside the air duct portion 120.

The air duct portion 120 may include a first air duct portion connected to the first fan module mounting portion and a second air duct portion connected to the second fan module mounting portion.

The first air duct portion and the second air duct portion, in order to be positioned between the first fan module mounting portion and the second fan module mounting portion, may be disposed the edge of the first fan module mounting portion adjacent to the center of the front surface of the mask body 10 and the edge of the second fan module mounting portion, respectively.

In addition, the first fan module mounting portion and the second fan module mounting portion may have symmetrical shapes based on a vertical plane (or vertical line) passing through the center of the front surface of the mask body 10. Similarly, the first air duct portion and the second air duct portion may also have symmetrical shapes based on a vertical plane or a vertical line passing through the center of the front surface of the mask body 10.

One end portion of the air duct portion 120 communicates with the outlets of the fan modules 16 and 17 so that outside air is introduced into the air duct portion 120. In addition, the other end portion of the air duct portion 120 communicates with the air discharge opening 129, so that the outside air introduced into the air duct portion 120 is ejected to the breathing space.

A control module 18 may be mounted on the front surface of the air duct portion 120.

A portion of the air duct portion 120 may be formed as a curved portion 1201, and the remaining portion of the air duct portion 120 may be formed as a flat portion 1202. The control module 18 may be fixed to the flat portion 1202. The curved portion 1201 of the air duct portion 120 comes into contact with the fan module mounting portion 110 to allow outside air to be introduced therein, and the flat portion 1202 comes into contact with the air discharge opening 129 to allow the introduced outside air to be supplied to the breathing space.

It can be described that the control module 18 is located in front of the flat portion and the flow path of the air duct portion 120 is located in the rear.

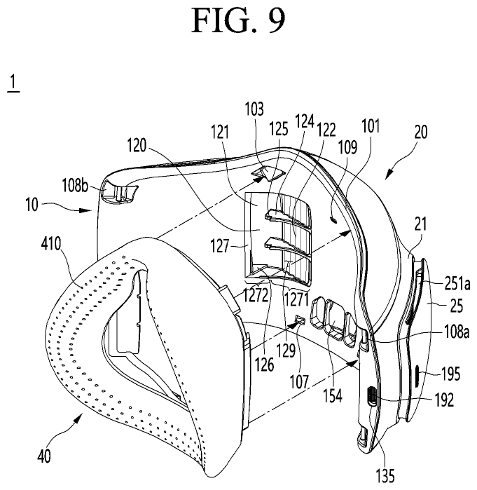

The front surface of the flat portion 1202 may be defined as a control module seating portion on which the control module 18 is seated. In addition, a concave-convex portion 122 to be described with reference to FIG. 9 may be formed on the rear surface of the flat portion 1202.

The mask body 10 may include a power module mounting portion 130 for mounting the power module 19 thereon.

The power module mounting portion 130 may be formed on the front surface of the mask body 10. The power module mounting portion 130 may be provided on any one side of the left and right sides of the mask body 10.

The power module mounting portion 130 may be located at a side of the fan module mounting portion 110. Specifically, the power module mounting portion 130 may be provided between the fan module mounting portion 110 and the side end portion of the mask body 10. The side end portion of the mask body 10 may be defined as an end portion adjacent to the user's ear when worn. In addition, the connector hole 135 may be located at the side end portion of the mask body 10 where the power module mounting portion 130 is provided.

The mask body 10 may include a battery mounting portion 140 for mounting a battery.

The battery mounting portion 140 may be formed centrally on the front surface of the mask body 10. The battery mounting portion 140 may protrude forward from the front surface of the mask body 10 and surround the battery.

For example, the battery mounting portion 140 may include a pair of guide ribs protruding forward from the front surface of the mask body 10 and a connection rib connecting front end portions of the pair of guide ribs. In addition, the battery may be mounted in a battery accommodation space defined by the pair of guide ribs and the connection rib.

The battery may be inserted into the battery accommodation space by moving from an upper side to a lower side of the battery accommodation space, and may be separated by moving in a reverse direction. A lower portion of the battery inserted into the battery mounting portion 140 may be supported by an air outlet 150 to be described later.

The mask body 10 may include an air outlet 150.

The air outlet 150 may be formed at a lower portion of the mask body 10. The air outlet 150 forms a flow space in which air flowing from the first air outlet 154 toward the second air outlet 155 flows.

The air outlet 150 may protrude forward from the front surface of the mask body 10. In addition, the air outlet 150 may be extended in an arch shape or may be bent multiple times and extended.

When the mask body cover 20 is coupled to the mask body 10, the front end portion of the air outlet 150 comes into contact with the rear surface of the mask body cover 20, and the inner space of the mask body 10 and the flow space are separated.

The air outlet 150 may define an upper surface and both side surfaces of the flow space, and a rear surface of the mask body cover 20 may define a front surface of the flow space. In addition, the front surface of the mask body 10 may define the rear surface of the flow space, and the bottom surface of the mask body 10 where the second air outlet 155 is formed may define the bottom surface of the flow space.

An upper surface of the air outlet 150 may support a lower end of the battery. Both lower ends of the air outlet 150 formed in an arch shape or tunnel shape are connected to the lower surface of the mask body 10, and the lower surface of the mask body 10 may be defined by a rib extending from the lower front surface of the mask body 10 to the front.

The cover coupling groove 101 is recessed along the front end of the rib forming the bottom surface of the mask body 10, and the lower end of the rear surface of the mask body cover 20 is coupled to the cover coupling groove 101.

The first air outlet 154 may be formed on the front surface of the mask body 10 defining the rear surface of the flow space.

As described above, the mask body cover 20 may include a pair of filter mounting portions 21 and 22.

The filter mounting portions 21 and 22 may be formed by recessing the front surface of the mask body cover 20 toward the rear surface by a predetermined depth. The filters 23 and 24 are accommodated inside the filter mounting portions 21 and 22 formed by being recessed, and the filter cover 25 and 26 may be mounted on the edge of the filter mounting portions 21 and 22 in a state where the filters 23 and 24 are accommodated.

Air suction openings 211 and 221 may be formed in the filter mounting portions 21 and 22. The air suction openings 211 and 221 may communicate with fan suction openings formed on front surfaces of the fan modules 16 and 17. Edges of the air suction openings 211 and 221 may have inclined surfaces inclined in a direction in which diameters decrease from the front to the rear.

Filter cover mounting grooves 212 and 222 for fixing the filter covers 25 and 26 may be formed on side surfaces of the filter mounting portions 21 and 22. Coupling protrusions inserted into the filter cover mounting grooves 212 and 222 may be formed on the filter covers 25 and 26. Although only the coupling protrusion formed on the left filter cover 26 is illustrated in FIG. 5, it should be noted that the same coupling protrusion is also formed on the right filter cover 25.

A sealing material may be provided between the rear edges of the air suction openings 211 and 221 of the filter mounting portions 21 and 22 and the fan suction openings of the fan modules 16 and 17. The sealing material surrounds edges of the air suction openings 211 and 221 and the suction openings of the fan modules 16 and 17 to prevent external air from being introduced.

Alternatively, instead of providing the sealing material, orifices are formed at the edges of the air suction openings 211 and 221, and the orifices come into close contact with the edges of the fan suction openings of the fan modules 16 and 17 so that the introduction of outside air may be prevented. The orifice may be understood as a guide rib that extends or protrudes rearward along the edge of the air suction openings 211 and 221.

The filter mounting portions 21 and 22 may include a first filter mounting portion 21 provided on the right side of the mask body cover 20 and a second filter mounting portion 22 provided on the left side of the mask body cover 20.

An air suction opening formed in the first filter mounting portion 21 may be defined as a first air suction opening 211, and an air suction opening formed in the second filter mounting portion 22 may be defined as a second air suction opening 221.

The filters 23 and 24 may include a first filter 23 accommodated inside the first filter mounting portion 21 and a second filter 24 accommodated inside the second filter mounting portion 22.

The filter covers 25 and 26 may include a first filter cover 25 mounted on the first filter mounting portion 21 and a second filter cover 26 mounted on the second filter mounting portion 22. A plurality of first air inlets 251 for introducing external air may be formed in the first filter cover 25, and a plurality of second air inlets 261 for introducing external air may be formed in the second filter cover 26.

The control module 18 may be referred to as a first electronic circuit component, and the power module 19 may be referred to as a second electronic circuit component.

The fan modules 16 and 17 may include a fan, a fan motor, and a fan housing accommodating the fan and the fan motor. A fan suction opening through which air is introduced into the fan and a fan discharge opening through which air forcedly flowing by the fan is ejected may be formed in the fan housing.

It should be noted that the fan includes a centrifugal fan that suctions in air from the front of the mask body cover 20 and ejects the air to the side of the mask body 10, but does not exclude an axial fan or a cross-flow fan.

The air introduced into the first air inlet 251 and passed through the first filter 23 is suctioned into the first air suction opening 211. In addition, the air introduced into the second air inlet 261 and passed through the second filter 24 is suctioned into the second air suction opening 221.

The fan discharge opening of the first fan module 16 communicates with the first air duct portion to discharge air into the breathing space, and the fan outlet of the second fan module 17 communicates to the second air duct portion to eject air into the breathing space.

The control module 18 may control the operation of the mask device 1. The control module 18 may be fixed to the control module flat portion 1202.

The control module 18 may include a communication module and transmit/receive various types of information. The control module 18 may include a data storage module and store various types of information.

The control module 18 may control the operation of the fan modules 16 and 17. In detail, the control module 18 may control the operation of the fan modules 16 and 17 based on information detected by a sensor.

The control module 18 may be electrically connected to and interlocked with the power module 19, the fan modules 16 and 17, and the battery.

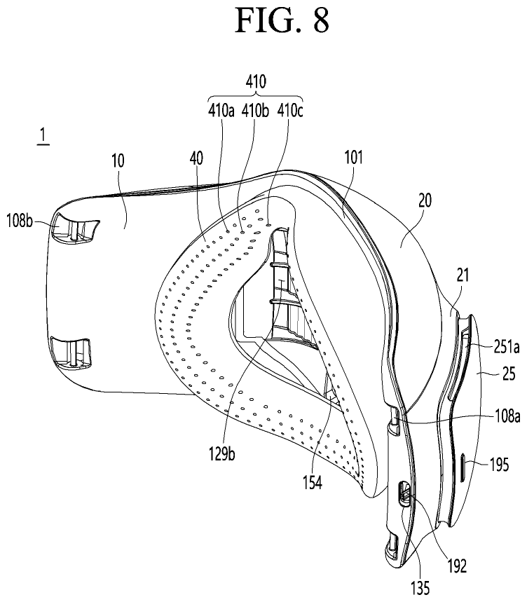

The power module 19 may receive power from the outside. The power module 19 may include a charging circuit for charging the battery. The power module 19 may include the connector 192 (see FIG. 8) and the manipulation portion 195. Accordingly, the control module 18 may operate by receiving battery power or external power through the connector 192.

The power module 19 may control power supply to the mask device 1 through manipulation of the manipulation portion 195. In detail, the power module 19 may control power supply from the battery to the control module 18 and the fan modules 16 and 17.

The sealing portion 40 may be coupled to the rear surface of the mask body 10 and is in close contact with the user's face.

The rear surface of the mask body 10 can be kept state of being spaced apart from the user's face by the sealing portion 40.

The sealing portion 40 may be formed in a ring shape forming a closed loop. The sealing portion 40 may be made of a material having elasticity. The sealing portion 40 may be in close contact with the user's face and deformed along the contour of the user's face.

The sealing portion 40 may be separably coupled from the mask body 10. With this structure, the sealing portion 40 can be separated from the mask body 10 and washed.

The sealing portion 40 may be coupled to the rear surface of the mask body 10. The sealing portion 40 may further include a first body coupling portion 404, a second body coupling portion 405, and a sealing insertion portion 406 for coupling with the mask body 10. The sealing portion 40 may further include a sealing close-contact portion 402 for being in close contact with the mask body 10. The sealing close contact portion 402 may protrude from the sealing portion 40 toward the mask body 10. When the sealing portion 40 is mounted on the rear surface of the mask body 10, the sealing close contact portion is interposed between the mask body 10 and the sealing portion 40 and thus blocks the gap between the mask body 10 and the sealing portion 40.

A second magnetic member 35 for coupling with the first magnetic member 15 is mounted on the sealing portion 40, and the sealing portion 40 to which the second magnetic member 35 is mounted is defined as a sealing assembly. A detailed structure of the sealing assembly will be described with reference to FIG. 8.

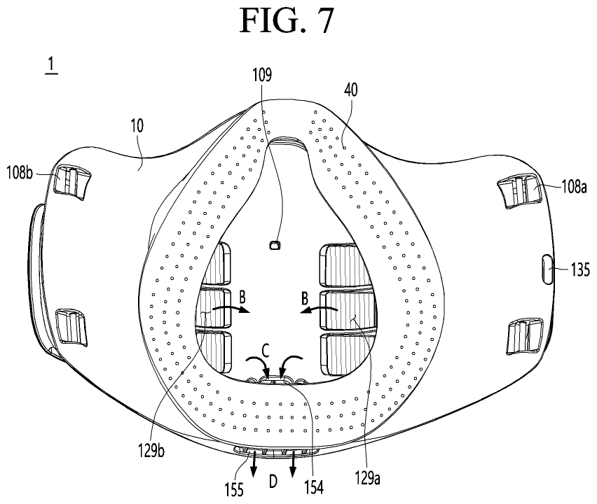

FIGS. 6 and 7 are views illustrating the flow of air when operating the mask device according to an embodiment of the present disclosure.

Referring to FIGS. 6 and 7, the mask device 1 according to the present disclosure may suction external air through air inlets 251 and 261 formed in filter covers 25 and 26. A flow direction of external air suctioned into the mask device 1 is indicated by A.

Since a plurality of air inlets 251 and 261 are configured to suction air in various directions, an inlet amount of external air can be increased.

For example, the air inlets 251 and 261 may include upper air inlets 251a and 261a for suctioning air flowing in the upper portion of the filter covers 25 and 26, side air inlets 251b and 261b for suctioning air flowing in the side of the filter covers 25 and 26, and lower air inlets 251c and 261c for suctioning air flowing in the lower portion of the filter covers 25 and 26. The side air inlets 251b and 261b may be formed on one or both sides of the left and right sides of the filter covers 25 and 26.

Since the filter covers 25 and 26 in which the air inlets 251 and 261 are formed are disposed on the left and right sides of the front surface of the mask device 1, the outside air can be smoothly suctioned from the left and right sides of the front surface of the mask device 1.

External air introduced through the air inlets 251 and 261 may filter foreign substances while passing through the filters 23 and 24 mounted inside the filter mount portions 21 and 22. The filters 23 and 24 can be replaced after separating the filter covers 25 and 26 from the mask device 1.

The air passing through the filters 23 and 24 may be introduced into the fan suction openings of the fan modules 16 and 17 through the air suction openings 211 and 221. Since the filter mounting portions 21 and 22 where the air suction openings 211 and 221 are formed and the fan modules 16 and 17 are assembled in a state of being in close contact with each other, it can be prevented air passing through the filter from being leaked to the outside or external air from being introduced between the filter mount portions 21 and 22 and the fan modules 16 and 17.

Air discharged through the fan discharge openings of the fan modules 16 and 17 may be introduced into the breathing space through the air discharge opening 129 after passing through the air duct portion 120. A flow direction of air introduced into the breathing space through the air discharge opening 129 is indicated by B.

The breathing space may be defined by the mask body 10 and the sealing portion 40. When the mask body 10 is brought into close contact with the user's face, the sealing portion 40 is brought into close contact with the mask body 10 and the user's face to form an independent breathing space separated from the external space.

When the user inhales and then exhales the filtered air supplied through the air discharge opening 129, the air that comes out may be discharged to an external space through the air outlets 154 and 155.

As described above, the air outlets 154 and 155 include a first air outlet 154 communicating with the breathing space and a second air outlet 155 communicating with the external space, and the first air outlet 154 and the second air outlet 155 may communicate with each other by a flow space defined by the air outlet 150. In other words, the air exhaled by the user is guided to the flow space through the first air outlet 154. A flow direction of air flowing into the flow space through the first air outlet 154 is indicated by C.

The air guided to the flow space through the first air outlet 154 may be discharged to an external space through the second air outlet 155. A flow direction of air discharged to the external space through the second air outlet 155 is indicated by D.

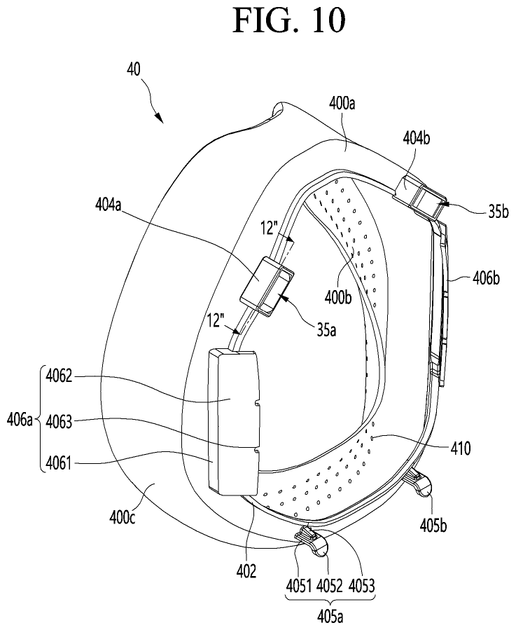

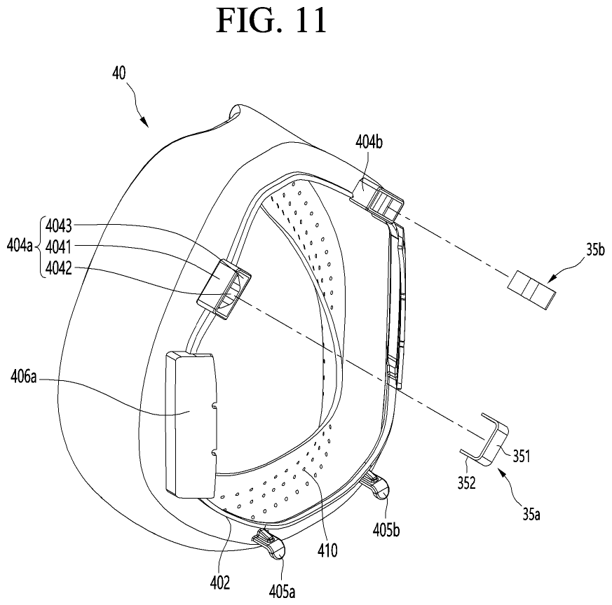

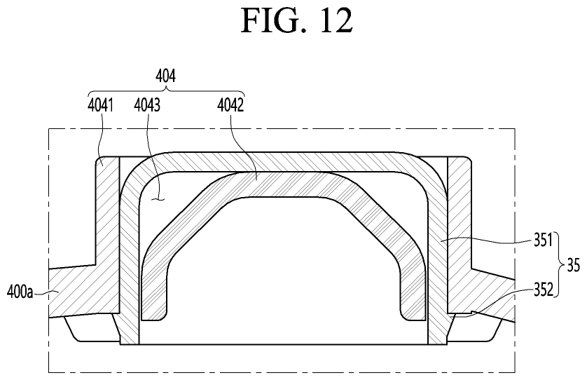

FIG. 8 is a view illustrating a sealing assembly mounted on a mask device according to an embodiment of the present disclosure, FIG. 9 is a view illustrating a sealing assembly separated from a mask device according to an embodiment of the present disclosure, FIG. 10 is a perspective view illustrating a sealing assembly according to an embodiment of the present disclosure, FIG. 11 is an exploded perspective view illustrating a sealing assembly according to an embodiment of the present disclosure, and FIG. 12 is a cross-sectional view taken along line 12″-12″ of FIG. 10.

Referring to FIGS. 8 to 12, a sealing assembly may be detachably coupled to the mask body 10 of the mask device 1 according to the present disclosure. The sealing assembly may be formed by coupling the second magnetic member 35 to the sealing portion 40.

A breathing space may be defined inside the sealing portion 40. The breathing space may communicate with the air outlet 129 and the air outlets 154 and 155 of the mask body 10. Air supplied through the air discharge opening 129 may be inhaled by the user, and air exhaled by the user may be discharged to an external space through the air outlets 154 and 155. The mask body 10 may be mounted on the user's face while the sealing portion 40 is in close contact with the user's face.

Hereinafter, structures for fixing the sealing portion 40 to the mask body 10 will be described based on the drawings.

The sealing portion 40 may be formed in a ring shape forming a closed loop. Since the sealing portion 40 is formed in a ring shape, a breathing space may be formed between the mask body 10 and the user's face by surrounding the user's nose and mouth. The sealing portion 40 can be deformed to be capable of being in close contact with the user's face, and can be made of a material that has excellent moisture resistance and airtightness and is easy to clean. For example, the sealing portion 40 may be made of a polymer material such as silicone or rubber.

The sealing portion 40 faces the mask body 10, and may include a sealing front portion 400a in contact with the mask body 10, a sealing rear portion 400b in contact with the user's face, and a sealing side portion 400c connecting the sealing front portion 400a and the sealing rear portion 400b.

The sealing rear portion 400b is a portion that is in close contact with the user's face, and the sealing side portion 400c and the sealing rear portion 400b form an angle of less than 90 degrees so that a space can be formed between the sealing side portion 400c and the sealing rear portion 400b. The sealing rear portion 400b may be formed by bending an end portion of the sealing side portion 400c. The sealing side portion 400c may be formed by bending an end portion of the sealing front portion 400a.

A breathing space may be defined inside the sealing front portion 400a, the sealing rear portion 400b, and the sealing side portion 400c.

The sealing front portion 400a is in close contact with the rear surface of the mask body 10, and may have a front opening for receiving air from the mask body 10 or discharging exhaled air. The sealing rear portion 400b may have a rear opening through which the user's nose and mouth are inserted.

The sealing portion 40 may be formed to cover the nose and mouth of the user's face. A nose seating groove recessed in a direction from the rear of the sealing portion 40 toward the front may be further formed on the upper portion of the sealing portion 40 so that the user's nose can be seated therein. In order to solve the problem that the lower portion of the sealing portion 40 is spaced apart by the user's chin when the user's lower portion is in close contact with the sealing portion 40, a chin seating groove may be formed which is recessed in a direction from the rear of the sealing portion 40 to the front.

The sealing portion 40 may include a sealing close contact portion 402. The sealing close contact portion 402 may protrude toward the mask body 10 from the sealing front portion 400a. The sealing close contact portion 402 may be provided at an inner end portion of the sealing front portion 400a. When the sealing portion 40 is mounted on the rear surface of the mask body 10, the sealing close contact part 402 is intervened between the mask body 10 and the sealing front portion 400a, and can block the gap formed between the mask body 10 and the sealing front portion 400a. The sealing close contact portion 402 may be formed to extend along an inner end portion of the sealing front portion 400a. The sealing close contact portion 402 may be connected to at least one of the first body coupling portion 404, the second body coupling portion 405, and the sealing insertion portion 406. In this embodiment, the sealing close contact portion 402 is illustrated in FIG. 10 as being connected to the first body coupling portion 404 and the sealing insertion portion 406.

The sealing portion 40 may include a first body coupling portion 404. A plurality of first body coupling portions 404 are provided and may be disposed on both sides of the upper portion of the sealing portion 40. The first body coupling portion 404 can be understood as a configuration that allows the sealing portion 40 to be fixed to the mask body 10. In this embodiment, the sealing portion 40 may be formed in a coupling structure to the mask body 10 through magnetism. At this time, the second magnetic member 35 may be fixed to the first body coupling portion 404. Without being limited to this idea, the first body coupling portion 404 may be transformed into a physical coupling structure or a coupling structure by a coupling material or the like. The plurality of first body coupling portions 404 may include a first body coupling portion 404a on one side and a first body coupling portion 404b on the other side.

The second magnetic member 35 may be provided for coupling with the first magnetic member 15 of the first sealing coupling portion 103. The second magnetic member 35 may be firmly fixed to the first body coupling portion 404. The first sealing coupling portion 103 and the first body coupling portion 404 may be coupled to each other by the first magnetic member 15 and the second magnetic member 35.

The second magnetic member 35 may be provided in a position and number corresponding to the first body coupling portion 404. The second magnetic member 35 may include a second magnetic member 35a on one side disposed on the right side of the sealing portion 40 and a second magnetic member 35b on the other side disposed on the left side corresponding to the first body coupling portion 404a on one side located on the right side of the sealing portion 40 and the first body coupling portion 404b on the other side of the sealing portion 40 located on the left side of the sealing portion 40.

The second magnetic member 35 may include a magnetic body 351 forming a body and a fixing protrusion 352 fixing the magnetic body 351 to the first body coupling portion 404. Both end portions of the magnetic body 351 may be bent in a rearward direction to form a substantially “=” shape. The fixing protrusions 352 protruding outward from the outer surface of the magnetic body 351 may be formed at both end portions of the magnetic body 351 that are bent. The magnetic body 351 may be transformed into various materials that are attracted by the magnetic force of the first magnetic member 15. Both end portions of the magnetic body 351 may be inserted into the first body coupling portion 404 and fixed by the fixing protrusion 352.

The first body coupling portion 404 may include a first body coupling portion body 4041 extending from the sealing front portion 400a, and an insertion guide 4042 provided inside the first body coupling portion body 4041, and an insertion hole 4043 formed between the first body coupling portion body 4041 and the insertion guide 4042 (see FIG. 12).

The first body coupling portion body 4041 may be formed in a shape into which the second magnetic member 35 can be inserted. For example, the first body coupling portion body 4041 may be formed in a polygonal shape protruding forward from the sealing front portion 400a. The inner side of the first body coupling portion body 4041 is opened, and the insertion guide 4042 may be provided inside the opened side. The insertion guide 4042 may be formed in an upwardly convex shape. The second magnetic member 35 may be seated while the insertion guide 4042 guides the insertion position of the second magnetic member 35. The second magnetic member 35 whose insertion position is guided by the insertion guide 4042 may be inserted into the insertion hole 4043. A plurality of insertion holes 4043 are provided, and both end portions of the second magnetic member 35 may be inserted into the plurality of insertion holes 4043. When the second magnetic member 35 is coupled to the first body coupling portion body 4041, the fixing protrusion 352 of the second magnetic member 35 may be engaged and fixed to the insertion hole 4043.

The sealing portion 40 may include a second body coupling portion 405. The second body coupling portion 405 is provided in plurality and may be disposed on both sides of the lower portion of the sealing portion 40. In this embodiment, the second body coupling portion 405 may be formed in a hook shape inserted into the second sealing coupling portion 107. The plurality of second body coupling portions 405 may include a second body coupling portion 405a on one side and a second body coupling portion 405b on the other side.

The second body coupling portion 405 may include a protrusion portion 4051 protruding forward from the sealing front portion 400a, a bent portion 4052 formed to be bent downward at an end portion of the protrusion portion 4051, and a reinforcing rib 4053 for reinforcing structural strength of the protrusion portion 4051 and the bent portion 4052. In the second body coupling portion 405, the protrusion portion 4051 is further inserted into the second sealing coupling portion 107 while the bent portion 4052 is inserted into the second sealing coupling portion 107, and thus a lower portion of the sealing portion 40 may be fixed to the mask body 10. The shape of the bent portion 4052 bent downward can prevent the second body coupling portion 405 from being easily separated from the second sealing coupling portion 107. A width of the bent portion 4052 may be greater than that of the protrusion portion 4051.

The lower portion of the sealing portion 40 where the second body coupling portion 405 is formed may protrude forward more than the upper portion of the sealing portion 40. The lower portion of the sealing portion 40 protrudes forward than the upper portion of the sealing portion 40 because the upper portion of the mask device 1 is located more forward than the lower portion when the mask device 1 is worn, and thus the occurrence of an unshielded space between the user's chin and the lower portion of the mask device 1 is minimized. This structure may be defined as a chin seating groove of the sealing portion 40.

The sealing portion 40 may include a sealing insertion portion 406. A plurality of sealing insertion portions 406 are provided and may be disposed on both sides of the central portion of the sealing portion 40. The sealing insertion portion 406 may be inserted into the cutout 127 of the mask body 10 and fixed to the mask body 10. The sealing insertion portion 406 may form a portion of the flow path of the air duct portion 120 to allow air to flow toward the air discharge opening 129. The plurality of sealing insertion portions 406 may include a sealing insertion portion 406a on one side and a sealing insertion portion 406b on the other side.

The sealing insertion portion 406 may include a protrusion frame 4061 and an insertion plate 4062. The protrusion frame 4061 may protrude forward from the body of the sealing portion 40. The protrusion frame 4061 can be understood as a configuration supporting the insertion plate 4062. The insertion plate 4062 may be positioned at an end portion of the protrusion frame 4061. The insertion plate 4062 can be understood as a configuration inserted into the second space 1272 of the cutout 127. Alternatively, the protrusion frame 4061 may protrude forward from the sealing portion 40, and a portion of the protrusion frame 4061 may be bent to form the insertion plate 4062.

Since the insertion plate 4062 is inserted into the second space 1272 of the cutout 127 to form a portion of the flow path of the air duct portion 120, the insertion plate may also be defined as the rear portion of the air duct portion 120. When the insertion plate 4062 is inserted into the second space 1272 of the cutout 127, the insertion plate 4062 is can be fixed to the mask body 10 by the sealing coupling groove 125 and the sealing support portion 126.

A branch insertion groove 4063 may be formed in the insertion plate 4062. The branch portion insertion groove 4063 can be understood as a configuration for inserting a portion of the branch portion 124 into the insertion plate 4062 inserted into the sealing coupling groove 125. The branch portion insertion groove 4063 may be configured to be fitted to both surfaces of the branch portion 124.

Meanwhile, the sealing portion 40 may include a plurality of ventilation holes 410. The ventilation hole 410 may remove moisture due to sweat that may occur on the user's face. In the ventilation hole 410, air in the breathing space may be ejected toward the user's face through the ventilation hole 410. The ventilation hole 410 may be formed in the sealing rear portion 400b in contact with the user's face. The plurality of ventilation holes 410 may have different diameters. For example, the diameter of the ventilation hole 410 may gradually increase from the inner edge to the outer edge of the sealing rear portion 400b.

A plurality of openings of the ventilation hole 410 may be disposed at regular intervals on the sealing rear portion 400b. The ventilation hole 410 may eject air from the sealing portion 40 to a portion contacting the user's face.

The ventilation hole 410 may be formed by arranging a plurality of holes. The ventilation holes 410 may include first ventilation holes 410a disposed in a first arrangement, second ventilation holes 410b arranged in a second arrangement, and third ventilation holes 410c arranged in a third arrangement. In this embodiment, the first ventilation hole 410a to the third ventilation hole 410c may have the same diameter. If the ventilation holes 410 are disposed in different arrangements, an air curtain is formed between the user's face and the sealing portion 40 by the ventilation holes 410, and moisture present in the user's face can be removed.

The first ventilation hole 410a is disposed adjacent to the outer circumferential surface of the sealing rear surface portion 400b, the third ventilation hole 410c is disposed adjacent to the inner circumferential surface of the sealing rear surface portion 400b, and the second ventilation hole 410b may be disposed between the first ventilation hole 410a and the third ventilation hole 410c.

A user may couple the sealing portion 40 to the mask body 10 in the following manner.

First, the second body coupling portion 405 of the sealing portion 40 is inserted into the second sealing coupling portion 107 so that the lower portion of the sealing portion 40 may be fixed to the lower portion of the mask body 10. Next, in a state where the second body coupling portion 405 is coupled to the second sealing coupling portion 107, the sealing insertion portion 406 is inserted into the cutout 127 so that the sealing portion 40 may be fixed so as to be located at the center of the rear surface of the mask body 10. Next, the second magnetic member 35 of the first sealing coupling portion 103 faces the first magnetic member 15 of the first body coupling portion 404, so that by the attraction between the magnetic members or between the magnetic member and the metal, the sealing portion 40 is coupled to the mask body 10 by through this, the first body coupling portion 404 can be fixed to the upper portion of the mask body 10. At this time, the sealing close contact portion 402 may be intervened between the mask body 10 and the sealing front portion 400a to block a gap formed therebetween.

When the sealing portion 40 is separated from the mask body 10, the separation operation proceeds in the reverse order of above coupling, and the sealing portion 40 is separated from the mask body 10 to be capable of proceeding washing operation of the sealing portion 40. In addition, a washing operation for the rear surface of the mask body 10 may be performed in a state where the sealing portion 40 is separated.

According to the present disclosure, it is possible to improve the convenience of maintenance of the sealing portion 40 by forming the sealing portion 40 with a single material. In addition, by improving the coupling structure between the sealing portion 40 and the mask body 10, the user can easily couple or separate it.

1. A mask device comprising:
a mask cover having an air suction opening for suctioning air;
a mask body coupled to the mask cover, having a fan module fixed thereto for flowing air introduced into the air suction opening, and has air discharge opening for ejecting the air flowing by means of the fan module and an air outlet for discharging the air to the outside; and
a sealing portion separably coupled to a rear surface of the mask body, and having a first body coupling portion supported on an upper portion of the mask body and a second body coupling portion supported on a lower portion of the mask body.

2. The mask device of claim 1,
wherein the sealing portion includes:
a sealing front portion contacting a rear surface of the mask body and having a front opening formed therein;
a sealing side portion extending rearward from the sealing front portion; and
a sealing rear portion connected to the sealing side portion and having a rear opening formed therein.

3. The mask device of claim 2,
wherein the first body coupling portion and the second body coupling portion are formed on the sealing front portion.

4. The mask device of claim 3,
wherein the first body coupling portion is separably coupled to the rear surface of the mask body by magnetic force.

5. The mask device of claim 4,
wherein a magnet member is provided on one of the mask body and the first body coupling portion, and
wherein a metal member coupled to the magnet member or another magnet member is provided to the other one of the mask body and the first body coupling portion.

6. The mask device of claim 5,
wherein the mask body is provided with a first sealing coupling portion to which the magnet member is fixed,
wherein the first body coupling portion includes:
a body protruding forward from the sealing front portion;
an insertion guide provided inside the body; and,
an insertion hole formed between the body and the insertion guide into which the metal member is inserted.

7. The mask device of claim 6,
wherein the metal member is formed such that both end portions are bent in one direction, and
wherein fixing protrusions engaged and fixed to the insertion holes are formed at both bent end portions.

8. The mask device of claim 3,
wherein the second body coupling portion includes:
a protrusion portion protruding forward from the sealing front portion; and
a bent portion bent downward at an end portion of the protrusion portion.

9. The mask device of claim 8,
wherein the mask body includes a second sealing coupling portion formed by opening to insert the protrusion portion and the bent portion into the mask body.

10. The mask device of claim 3,
wherein a plurality of first body coupling portions are provided to be spaced apart from the upper portion of the sealing front portion to both sides, and
wherein a plurality of second body coupling portions are provided to be spaced apart from the lower portion of the sealing front portion to both sides.

11. The mask device of claim 3,
wherein a sealing insertion portion is further formed on the sealing front portion so that a portion thereof is inserted into the air discharge opening and supported in the middle portion of the mask body.

12. The mask device of claim 11,
wherein a plurality of sealing insertion portion are provided to be spaced apart from the middle portion to both sides of the sealing front portion.

13. The mask device of claim 2,
wherein the front opening is formed to surround the air discharge opening and the air outlet,
wherein the rear opening is formed to surround the user's mouth and nose, and
wherein a breathing space is defined in a space between the front opening and the rear opening.

14. The mask device of claim 2,
wherein a plurality of ventilation holes are formed in the sealing rear portion.

15. The mask device of claim 2, further comprising:
a sealing contact portion protruding forward from the sealing front portion and interposed between the sealing front portion and the rear surface of the mask body.
